(19) United States
(12) Patent Application Publication
(10) Pub. No.: US 2010/0280710 A1
(43) Pub. Date: Nov. 4, 2010

(54) METHOD AND DEVICE FOR OPERATING A VEHICLE HAVING AT LEAST ONE DRIVER ASSISTANCE SYSTEM

(76) Inventors: Martin Staempfle, Schwieberdingen (DE); Fred Oechsle, Ludwigsburg (DE); Andreas Simon, Wolfenbuettel (DE); Jan-Carsten Becker, Vellmar (DE); Christian Schmidt, Stuttgart (DE); Katharina Witt, Braunschweig (DE)

Correspondence Address: KENYON & KENYON LLP, ONE BROADWAY, NEW YORK, NY, 10004, US

(21) Appl. No.: 12/303,723

(22) PCT Filed: Sep. 13, 2007
(86) PCT No.: PCT/EP2007/059654

§ 371 Date: Jun. 22, 2010

(30) Foreign Application Priority Data
Nov. 7, 2006 (DE) 10 2006 052 481.0

(51) Int. Cl. G06F 19/00; G10L 11/00

(52) U.S. Cl. 701/36; 704/275; 704/E11.001

(57) ABSTRACT

In a method for operating a vehicle, in particular a motor vehicle, having at least one driver assistance system, it is provided that the driver has the option of activating the driver assistance system in a critical driving situation, and that the driver assistance system assumes control of the vehicle upon activation without further action on the part of the driver. Furthermore, in a device for operating a vehicle, in particular a motor vehicle, having at least one driver assistance system, at least one actuation device able to be activated by the driver, which upon activation switches on the driver assistance system to assume control of the vehicle, in particular in critical driving situations.

### FIELD OF THE INVENTION

The present invention relates to a method for operating a vehicle, in particular a motor vehicle, which is equipped with at least one driver assistance system.

### BACKGROUND INFORMATION

Modern vehicles come equipped with driver assistance systems which support the driver in controlling the vehicle, a distinction being made between comfort and safety systems. For example, there are driver assistance systems which intervene in a steering system, a brake and/or in the rotational speed of an internal combustion engine and thereby, for instance, prevent the vehicle from breaking away in a curve or driving too closely to a vehicle traveling ahead. Such driver assistance systems are finding increased use and are based on the detection of the vehicle environment with the aid of what is generally known as a surround sensor system. Also known are driver assistance systems that render assistance to the driver in critical driving situations, for example by an emergency braking operation without involvement of the driver.

### SUMMARY

According to example embodiments of the present invention, it is provided that the driver is given the option of activating the driver assistance system in a critical driving situation, and that the driver assistance system assumes the control over the vehicle upon activation, without further action by the driver. For example, if the driver considers a driving situation critical, then he is able to decide whether he wishes to respond to the driving situation by himself, for instance by evasive maneuvering or by an emergency braking operation, or, if possible, whether he wishes to hand over control of the vehicle to an assistance system if he believes himself no longer able to resolve or defuse the driving situation on his own. The driver therefore has the option of actively transferring the control of the vehicle. This is also advantageous from a legal and liability standpoint.

The driver may advantageously activate the driver assistance system only if an automatic detection system detects a critical driving situation simultaneously or within a specifiable time interval. This prevents faulty triggering or activation of the driver assistance system or an unintentional transfer of the control over the vehicle to the driver assistance system. In the process, a critical driving situation may be detected automatically, for instance by an installed surround sensor system equipped with infrared and/or radar sensors, for example. If the driver and the surround sensor system therefore detect a critical driving situation, then the driver is able to activate the driver assistance system. In an advantageous manner, a time interval is specified within which the driver can activate the driver assistance system. The time interval begins at the instant, for example, at which a critical driving situation was detected automatically. As an alternative, the time interval may also begin at the instant at which the driver has indicated his wish for activation of the driver assistance system, so that the surround sensor system or the automatic driving situation detection is activated as soon as the time interval begins and it was, or was not, confirmed within the specified time interval that the driving situation is critical.

According to example embodiments of the present invention, the activation of the driver assistance system is implemented by the driver by voice input. This has the advantage that the driver will not have to take his hands off the steering wheel of the vehicle or turn his eyes away from the traffic in order to activate the driver assistance system, so that he continues to maintain an overview of the driving situation and retains control over the vehicle until the driver assistance system is activated.

The activation by the driver is advantageously implemented by at least one specific word. This word must of course be known to the driver and be as uncomplicated as possible, so that the driver is able to respond quickly. According to example embodiments of the present invention, the activation by the driver may also be implemented by a plurality of spoken words, in the form of a sentence.

The activation by the driver preferably takes place manually or must take place manually in addition to the spoken input/word. Thus, the driver has the option of activating the driver assistance system by pressing a key or a switch, for example. In an advantageous manner, the manual activation of the driver assistance system must take place as an additional condition to the voice input/word and/or the automatic detection of a critical driving situation, so that the driver assistance system assumes control over the vehicle only in those instances where, for example, all conditions are satisfied, i.e., speech input/word, detected critical driving situation by the automatic detection, and manual activation.

According to example embodiments of the present invention, a voice recognition takes place to identify the driver and/or the spoken input of the driver and/or the specific, at least one word of the driver. The driver must submit a voice sample to the driver assistance system for this purpose, e.g., when the driver assistance system is installed, so that it is able to be activated only when the driver is identified. This prevents that, for example, a passenger can activate the driver assistance system. The speech recognition system preferably identifies the specific at least one word of the driver; when submitting the voice sample, the driver specifies this at least one word to the driver assistance system, or “stores” it therein. In an advantageous manner, the driver is able to activate the speech recognition system by actuating a pushbutton, which then identifies the speech input of the driver or his spoken word.

Furthermore, example embodiments of the present invention relate to a device for operating a vehicle, in particular a motor vehicle, which has at least one driver assistance system, at least one actuation device activatable by the driver, which turns on the driver assistance system upon activation in order to assume control of the vehicle, especially in critical driving situations.

According to example embodiments of the present invention, the actuation device includes at least one switch and/or a pushbutton key, which is able to be actuated manually by the driver. In an advantageous manner, the switch and/or pushbutton key are/is situated in the vehicle in such a way that the driver may access it easily and also locate it quickly, so that the driver is able to rapidly respond to the driving situation or activate the driver assistance system.

The actuating device advantageously includes at least one speech recognition device, which is able to identify the driver and/or the speech and/or at least one particular spoken word of the driver, as described earlier. The speech recognition device expediently includes at least one microphone, which is disposed in the vicinity of the driver in the vehicle.

In the following text, example embodiments of the present invention are explained in greater detail with the aid of a several figures.

### BRIEF DESCRIPTION OF THE DRAWINGS

FIG. 1 illustrates an exemplary embodiment of the method according to the present invention;

FIG. 2 illustrates an exemplary embodiment of the method according to the present invention; and

FIG. 3 illustrates an exemplary embodiment of a device according to the present invention.

### DETAILED DESCRIPTION

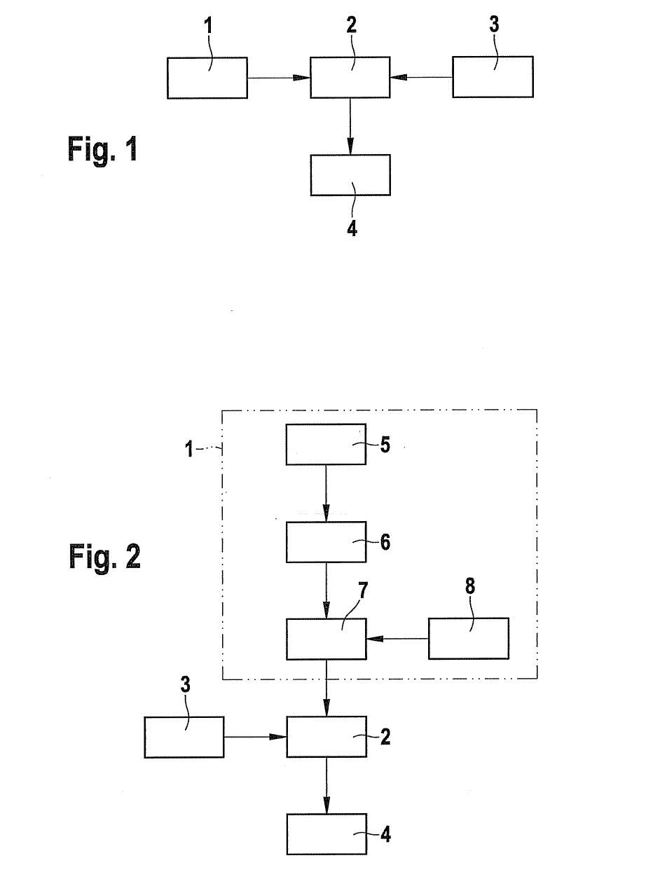

FIG. 1 shows an exemplary embodiment of the method according to the present invention in the form of a block diagram. In a first step 1, in a critical driving situation the driver manually or acoustically issues an instruction for activation of a driver assistance system, which is to assume control over the vehicle. In a second step 2, it is checked whether a surround sensor system 3 which is part of the vehicle and which, for example, detects the environment of the vehicle with the aid of radar and/or infrared sensors, and evaluates the instantaneous driving situation, considers the instantaneous driving situation critical as well. If this is the case, then the driver assistance system is activated in a third step 4, so that the driver assistance system assumes control over the vehicle without further action on the part of the driver. In this manner, the driver instructs the vehicle to resolve or defuse the critical driving situation on its own. Step 1 and step 2 of the method may occur simultaneously, but need not necessarily do so. The activation of the driver assistance system in step 4 advantageously occurs when the driver and the driver assistance system detect the driving situation as critical within a specified time interval, or when the driver outputs the instruction for activation of the driver assistance system, and the surround sensor system has evaluated the driving situation as critical.

Due to the active transfer of the control over the vehicle to the driver assistance system, the driver is able to express the transfer of the control explicitly if he believes himself unable to resolve the critical situation on his own. Furthermore, the driver assistance system does not assume the control over the vehicle if the driver wishes to resolve or defuse the driving situation on his own, for instance by an evasive maneuver or an emergency braking operation.

FIG. 2 shows an exemplary embodiment of the method, once again in a block diagram, the exemplary embodiment representing an expansion of the first described exemplary embodiment. In this instance, the first step 1, depicted as box encased by dashed lines here, is subdivided into a plurality of intermediate steps. In a first intermediate step 5, the driver initially outputs manual instructions for the activation of the driver assistance system, for instance by actuating a switch or pushbutton key. This actuation activates a speech recognition device. In second intermediate step 6, the driver outputs acoustic instructions, for instance by a spoken word or a spoken sentence, to activate the driver assistance system, these instructions being detected by the speech recognition device. In a third intermediate step 7, the acoustic instructions of the driver are compared to a voice sample 8, which the driver has submitted to, or stored in, the device during installation of the driver assistance system. The driver has advantageously stored the word or the sentence for activation of the driver assistance system. This has the advantage of preventing a triggering or activation of the driver assistance system by another person. With the aid of intermediate steps 5 through 7, the driver indicates his desire for activation of the driver assistance system according to step 1. As in the first exemplary embodiment of FIG. 1, it is then checked whether surround sensor system 3 considers the driving situation critical as well, whereupon the driver assistance system is either activated or not activated in the fourth step.

The activation of the speech recognition device in intermediate step 5 may alternatively also be implemented in that surround sensor system 3 detects a critical driving situation, or it may be omitted entirely so that the speech recognition device is activated at all times.

The speech recognition device is advantageously activated automatically if surround sensor system 3 detects a critical driving situation.

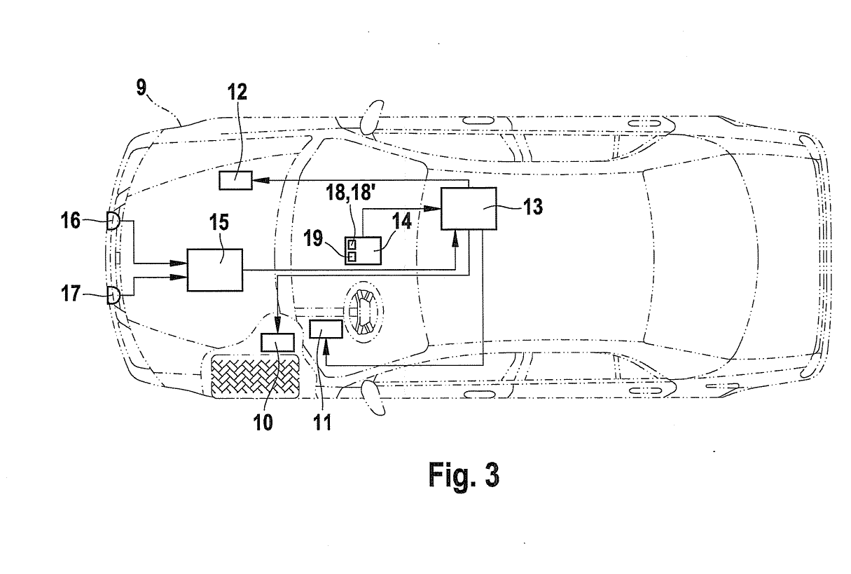

FIG. 3 shows an exemplary embodiment of a device for operating a vehicle 9, which includes a plurality of driver assistance systems 10, 11, and 12. Driver assistance systems 10 through 12 are designed in such a way, for instance, that driver assistance system 10 is able to influence the brakes of vehicle 9, and that driver assistance system 11 is able to influence the steering of vehicle 9, and that vehicle assistance system 12 is able to influence the rotational speed of the internal combustion engine of vehicle 9. Driver assistance systems 10 through 12 are connected to a control unit 13 of vehicle 9. An actuating device 14 and a surround sensor system 15 are likewise connected to control unit 13. Surround sensor system 15 detects the instantaneous driving situation of vehicle 9, e.g., with the aid of infrared sensors 16 and/or radar sensors 17, and analyzes the acquired data. The driver has the option of outputting instructions for the activation of driver assistance systems 10 through 12 to control unit 13 via actuating device 14. Control unit 13 advantageously activates driver assistance systems 10 through 12 only if surround sensor system 15 considers the instantaneous driving situation critical. Actuating device 14 advantageously includes a switch 18 or pushbutton key 18′ and/or a speech recognition device 19, which are/is used in the manner described above. Actuating device 14 advantageously is situated inside the vehicle in such a way that the driver is easily and quickly able to reach switch 18 or pushbutton key 18′ and speech recognition device 19 is able to detect the voice of the driver in satisfactory manner.

1-10. (canceled)

11. A method for operating a vehicle including at least one driver assistance system, comprising:
activating, under an option of a driver, the driver assistance system in a critical driving situation; and
assuming control, by the driver assistance system, over the vehicle upon activation without further action by the driver.

12. The method according to claim 11, wherein the vehicle is arranged as a motor vehicle.

13. The method according to claim 11, wherein driver assistance system is activatable by the driver only if, at least one of (a) simultaneously and (b) within a specified time interval, a critical driving situation is also determined with the aid of an automatic detection system.

14. The method according to claim 11, wherein the activation by the driver is implemented via speech.

15. The method according to claim 11, wherein the activation by the driver is implemented by at least one specific word.

16. The method according to claim 11, wherein the activation by the driver is at least one of (a) implemented manually and (b) implemented manually in addition to at least one of (i) speech and (ii) a word.

17. The method according to claim 11, wherein a speech recognition is implemented to identify at least one of (a) the driver, (b) speech of the driver, and (c) a specific, at least one word of the driver.

18. The method according to claim 17, wherein the speech recognition is activated when a critical driving situation has been determined with the aid of the automatic detection system.

19. A device for operating a vehicle including at least one driver assistance system, comprising:
at least one actuation device activatable by a driver and adapted to, upon activation, switch on the driver assistance system for the purpose of at least one of (a) assuming control of the vehicle and (b) assuming control of the vehicle in critical driving situations.

20. The device according to claim 19, wherein the vehicle is arranged as a motor vehicle.

21. The device according to claim 19, wherein the actuation device includes at least one of (a) at least one switch and (b) at least one pushbutton key.

22. The device according to claim 19, wherein the actuation device includes at least one speech recognition device.
